(19) United States
(12) Patent Application Publication
(10) Pub. No.: US 2021/0198876 A1
(43) Pub. Date: Jul. 1, 2021

(54) WATER OUTLET DEVICE AND KITCHEN FAUCET

(71) Applicant: Xiamen Solex High-Tech Industries Co., Ltd., Xiamen (CN)

(72) Inventors: Fengde Lin, Xiamen (CN); Donghai CHEN, Xiamen (CN); Chunjie HONG, Xiamen (CN); Bin CAO, Xiamen (CN)

(21) Appl. No.: 17/138,860

(22) Filed: Dec. 30, 2020

(30) Foreign Application Priority Data
Dec. 30, 2019 (CN) 201911395757.4

(51) Int. Cl. E03C 1/04

(52) U.S. Cl. CPC E03C 1/0405; E03C 2001/0415

(57) ABSTRACT

The present disclosure discloses a water outlet device and a kitchen faucet. The water outlet device comprises three water outlet passages, a first water outlet portion comprising one or more first water outlet nozzles, a second water outlet portion comprising one or more second water outlet nozzles, and a third water outlet portion. Each of the first water outlet portion and the second water outlet portion respectively has an annular structure. The second water outlet portion is separated from the first water outlet portion in an upper and lower direction. The one or more second water outlet nozzles correspond to the one or more first water outlet nozzles to enable fluid ejected from the one or more second water outlet nozzles to pass through the one or more first water outlet nozzles.

### RELATED APPLICATIONS

This application claims priority to Chinese patent application number 201911395757.4, filed on Dec. 30, 2019. Chinese patent application number 201911395757.4 is incorporated herein by reference.

### FIELD OF THE DISCLOSURE

The present disclosure relates to sanitary wares, and in particular relates to a water outlet device and a kitchen faucet.

### BACKGROUND OF THE DISCLOSURE

Existing water outlet devices in the sanitary field, such as described in CN103223382B, which describes a sprinkler assembly for a faucet, comprises: a main body configured to receive a fluid supply and an end surface in fluid connection with the main body. The end surface has a plurality of nozzles in a non-linear arrangement for guiding fluid from the sprinkler. The plurality of nozzles are configured to guide fluid flow to form a wedge-shaped spray between the end surface and a focus area, which is located at a focal length of the sprinkler. The spray forms a linear spray arrangement in the focal area, and the spray comprises a plurality of fluid streams. Each of the plurality of fluid streams corresponds to one of the plurality of nozzles, and each of the plurality of fluid streams is configured to be between the end surface and the focus area and is configured to avoid intersecting any other fluid stream of the plurality of fluid streams. The plurality of nozzles of the sprinkler assembly can only provide a single spray pattern, and each of the plurality of fluid streams is configured to be between the end surface and the focus area and is configured to avoid intersecting with any other fluid stream of the plurality of fluid streams, causing the fluid spray to be easily splashed.

Another water outlet device is disclosed in CN205731687U, which provides a shower with adjustable impact force and angle of splash. The shower comprises a housing, a water dividing plate, a middle plate, a water barrier, an inner water outlet panel, and an outer water outlet panel. The housing has a cavity with one end open, and the water dividing plate, the middle plate, the water barrier, and the inner water outlet panel are all disposed in the cavity of the housing. The outer water outlet panel is fastened on the open end of the housing. The water dividing plate is placed in the cavity of the housing, and the middle plate, the water barrier, and the outer water outlet panel are fixedly sleeved together. The inner water outlet panel is arranged between the water barrier and the outer water outlet panel, and multiple outlet holes of the inner water outlet panel are disposed opposite to multiple outlet holes of the outer water outlet panel. A top of the middle plate is provided with a rotating shaft, which is rotatably sleeved in a middle hole of the water dividing plate. A water passage of the housing passes through a water passage of the water dividing plate and the middle plate and is divided into two passages. One of the two passages is connected to the multiple outlet holes of the outer water outlet panel, and the other of the two passages is connected to the multiple outlet holes of the outer water outlet panel after passing through the multiple outlet holes of the inner water outlet panel. An outlet nozzle of the inner water outlet panel is inserted into an outlet nozzle of the outer water outlet panel, causing the outer water outlet panel to eject water along an annular gap of the outlet nozzles of the inner water outlet panel and the outer water outlet panel when the outer water outlet panel emits water, and the water spray is poor in practicality.

### BRIEF SUMMARY OF THE DISCLOSURE

The present disclosure provides a water outlet device and a kitchen faucet to solve the deficiencies of the conventional water outlet device in the sanitary wares of the background.

In order to solve the technical problem, a first technical solution of the present disclosure is as follows.

A water outlet device comprises three water outlet passages, a first water outlet portion comprising one or more first water outlet nozzles, a second water outlet portion comprising one or more second water outlet nozzles, and a third water outlet portion. Each of the first water outlet portion and the second water outlet portion respectively has an annular structure. The second water outlet portion is separated from the first water outlet portion in an upper and lower direction. The one or more second water outlet nozzles correspond to the one or more first water outlet nozzles to enable fluid ejected from the one or more second water outlet nozzles to pass through the one or more first water outlet nozzles. The third water outlet portion is disposed in the annular structures of the first water outlet portion and the second water outlet portion. The three water outlet passages are respectively in communication with the one or more first water outlet nozzles, the one or more second water outlet nozzles, and the third water outlet portion.

In an embodiment, ends of the one or more second water outlet nozzles are separated from an inner end surface defined by inner ports of the one or more first water outlet nozzles in the upper and lower direction by a gap.

In an embodiment, the second water outlet portion is separated from the first water outlet portion in the upper and lower direction to define an area, and the area defines a portion of a first water outlet passage of the third water outlet passages in communication with the one or more first water outlet nozzles.

In an embodiment, the one or more first water outlet nozzles comprises a plurality of first water outlet nozzles, and the plurality of first water outlet nozzles are evenly and circumferentially disposed at intervals. The one or more second water outlet nozzles comprises a plurality of second water outlet nozzles, and the plurality of second water outlet nozzles are evenly and circumferentially disposed at intervals.

In an embodiment, the annular structures of the first water outlet portion and the second water outlet portion are circular annular structures, the plurality of first water outlet nozzles and the plurality of second water outlet nozzles are both annularly arrayed relative to axis of the circular annular structures, and the plurality of second water outlet nozzles are aligned with the plurality of first water outlet nozzles in the upper and lower direction.

In an embodiment, the first water outlet portion comprises a first water outlet cover defining a first annular structure, an inner periphery and an outer periphery of the first water outlet cover respectively extend upward to define a first inner peripheral wall and a first outer peripheral wall, and the first water outlet cover comprises the one or more first water outlet nozzles. The second water outlet portion comprises a second water outlet cover defining a second annular structure, an inner periphery and an outer periphery of the second water outlet cover respectively extend upward to define a second inner peripheral wall and a second outer peripheral wall, and the second water outlet cover comprises the one or more second water outlet nozzles. The second water outlet portion is disposed between the first inner peripheral wall and the first outer peripheral wall. The second water outlet cover is separated from the first water outlet cover in the upper and lower direction.

In an embodiment, in a projection along an ejecting direction of the one or more second water outlet nozzles, inner walls of the one or more first water outlet nozzles encompass water outlet ports of the one or more second water outlet nozzles.

In an embodiment, the one or more first water outlet nozzles comprise a plurality of first water outlet nozzles, the one or more second water outlet nozzles comprise a plurality of second water outlet nozzles, and fluid ejected from at least two second water outlet nozzles of the plurality of second water outlet nozzles collides in a focus area or collides between the water outlet device and the focus area.

In an embodiment, at least some second water outlet nozzles of the plurality of second water outlet nozzles are divided into two second water outlet nozzle groups, fluid ejected from the two second water outlet nozzle groups collides in the focus area or collides between the water outlet device and the focus area, and collision points of the two second water outlet nozzle groups define an arc-shaped lattice structure.

In an embodiment, the plurality of second water outlet nozzles are all divided into two second water outlet nozzle groups, and fluid ejected from the two second water outlet nozzle groups collides in the focus area.

In an embodiment, at least some second water outlet nozzles of the plurality of second water outlet nozzles are divided into two second water outlet nozzle groups, fluid ejected from the two second water outlet nozzle groups intersects in different planes, an intersecting position of the different planes defines the focus area, and fluid ejected from remaining second water outlet nozzles of the plurality of second water outlet nozzles not divided into the two second water outlet nozzle groups collides between the water outlet device and the focus area.

In an embodiment, a cross section of the fluid ejected from the two second water outlet nozzle groups defines an arc-shaped lattice structure at the focus area.

In an embodiment, a cross section of the fluid ejected from the two second water outlet nozzle groups defines a first arc-shaped lattice structure at the focus area, and collision points of the remaining second water outlet nozzles define a second arc-shaped lattice structure.

In an embodiment, a cross section of the fluid ejected from the two second water outlet nozzle groups defines in an arc-shaped lattice structure at the focus area, and the arc-shaped lattice structure surrounds collision points of the remaining second water outlet nozzles.

In an embodiment, the one or more first water outlet nozzles comprise a plurality of first water outlet nozzles. The one or more second water outlet nozzles comprise a plurality of second water outlet nozzles. At least some second water outlet nozzles of the plurality of second water outlet nozzles are divided into two second water outlet nozzle groups, fluid ejected from the two second water outlet nozzle groups intersect in different planes, an intersecting position of the different planes defines a focus area, and a cross section of the fluid ejected from the two second water outlet nozzle groups defines an arc-shaped lattice structure in the focus area.

In order to solve the technical problem, a second technical solution of the present disclosure is as follows.

A water outlet device comprises a first water outlet passage, a first water outlet portion comprising one or more first water outlet nozzles, a second water outlet passage, and a second water outlet portion comprising one or more second water outlet nozzles. The one or more first water outlet nozzles are in communication with the first water outlet passage, and the one or more second water outlet nozzles are in communication with the second water outlet passage. The second water outlet portion is separated from the first water outlet portion in an upper and lower direction. Ends of the one or more second water outlet nozzles are separated from an end surface defined by inner ports of the one or more first water outlet nozzles in the upper and lower direction by a gap. The one or more second water outlet nozzles correspond to the one or more first water outlet nozzles to enable fluid ejected from the one or more second water outlet nozzles to pass through the one or more first water outlet nozzles.

In order to solve the technical problem, a third technical solution of the present disclosure is as follows.

A water outlet device comprises a water outlet passage and a water outlet portion comprising a plurality of water outlet nozzles. The plurality of water outlet nozzles are in communication with the water outlet passage. Fluid ejected from at least two water outlet nozzles of the plurality of water outlet nozzles collides in a focus area or collides between the water outlet device and the focus area.

In order to solve the technical problem, a fourth technical solution of the present disclosure is as follows.

A kitchen faucet comprises a body portion, a waterway control device, and the water outlet device. The body portion comprises a water inlet passage, and the waterway control device is connected to the water inlet passage and the three water outlet passages so as to alternatively switch the three water outlet passages to be in communication with the water inlet passage.

In an embodiment, the waterway control device comprises a first switching mechanism and a second switching mechanism. The body portion comprises a water dividing passage. The three water outlet passages are respectively a first water outlet passage, a second water outlet passage, and a third water outlet passage. The first switching mechanism is connected to the second water outlet passage, the water dividing passage, and the water inlet passage to alternatively switch the second water outlet passage and the water dividing passage to be in communication with the water inlet passage. The second switching mechanism is connected to the water dividing passage, the first water outlet passage, and the third water outlet passage to alternatively switch the first water outlet passage and the third water outlet passage to be in communication with the water dividing passage.

In an embodiment, the body portion comprises a body, a first water dividing body, and a second water dividing body, and the first water dividing body and the second water dividing body are disposed in the body. The water outlet device is secured to the body and cooperates with the second water dividing body. The first switching mechanism is disposed on the first water dividing body, and the second switching mechanism is disposed on the second water dividing body.

Compared with the existing techniques, the technical solution has the following advantages.

The water outlet device comprises three water outlet passages and three water outlet portions. The first water outlet portion and the second water outlet portion both have an annular structure, and the second water outlet portion is separated from the first water outlet portion in an upper and lower direction. The third water outlet portion is disposed in the annular structures of the first water outlet portion and the second water outlet portion. The second water outlet nozzle corresponds to the first water outlet nozzle so that the fluid ejected from the second water outlet nozzle can pass through the first water outlet nozzle, and “the annular structure” cleverly cooperates with “the two water outlet portions correspond up and down and cooperate with the two water outlet passages to outflow two kinds of water sprays”. The water outlet device can outflow three kinds of water sprays in the two water outlet areas, and the layout is reasonable and the structure is compact. This effect is particularly effective when used in kitchen faucets.

The end of the second water outlet nozzle and the inner end surface defined by the inner port of the first water outlet nozzle are separated up and down by a gap, which can prevent the second water outlet nozzle from interfering with the first water outlet nozzle and ensure that the outflow shape of the first water outlet nozzle is not affected. Increasing the distance between the first water outlet portion and the second water outlet portion can improve the uniformity of water discharge of the first water outlet nozzle of the first water outlet portion.

A plurality of water outlet nozzles are evenly arranged at intervals in the circumferential direction, which is especially convenient for arrangement within the first water outlet portion and the second water outlet portion having annular structures, with compact structure and reasonable layout.

The second water outlet portion is disposed between the first inner peripheral wall and the first outer peripheral wall, and the second water outlet cover is separated from the first water outlet cover in the upper and lower direction, which is convenient for assembly and compact in structure.

The fluid ejected from at least two of the plurality of second water outlet nozzles collide in the focus area or between the water outlet device and the focus area. The collision forms a particle-shaped water curtain to prevent water splashing and improve fluid impact. This effect is particularly prominent on the kitchen faucet, which is convenient for washing and cleaning.

The collision points of the two second water outlet nozzle groups define an arc-shaped lattice structure with beautiful appearance and large cleaning area.

The fluid ejected from the two second water outlet nozzle groups collide in the focus area, which has a beautiful appearance and prevents water splashing.

### BRIEF DESCRIPTION OF THE DRAWINGS

The present disclosure will be further described below in combination with the accompanying drawings and embodiments.

FIG. 1 illustrates a perspective view of a kitchen faucet in Embodiment 1.

FIG. 2 illustrates a first exploded perspective view of the kitchen faucet in Embodiment 1.

FIG. 3 illustrates a second exploded perspective view of the kitchen faucet in Embodiment 1.

FIG. 4 illustrates a first cross-sectional view of water discharge of the kitchen faucet in Embodiment 1 when water flows out of a third water outlet portion.

FIG. 5 illustrates a second cross-sectional view of water discharge of the kitchen faucet in Embodiment 1 when water flows out of a first water outlet portion.

FIG. 6 illustrates a third cross-sectional view of the kitchen faucet in Embodiment 1.

FIG. 7 illustrates a first perspective view of water discharge of the kitchen faucet in Embodiment 1 when water flows out of a second water outlet portion.

FIG. 8 illustrates a second perspective view of water discharge of the kitchen faucet in Embodiment 1 when water flows out of the second water outlet portion.

FIG. 9 illustrates a schematic view of water discharge of the second water outlet portion of Embodiment 1.

FIG. 10 illustrates a fourth cross-sectional view of the kitchen faucet in Embodiment 1 when water flows out of the second water outlet portion.

FIG. 11 illustrates a cross-sectional view of FIG. 10 taken along line B-B.

FIG. 12 illustrates a bottom view of water discharge of the kitchen faucet in Embodiment 1.

FIG. 13 illustrates a schematic view of water discharge of Embodiment 2 when water flows out of a second water outlet portion.

FIG. 14 illustrates a schematic view of water discharge of Embodiment 3 when water flows out of a second water outlet portion.

FIG. 15 illustrates a schematic view of water discharge of Embodiment 4 when water flows out of a second water outlet portion.

### DETAILED DESCRIPTION OF THE EMBODIMENTS

### Embodiment 1

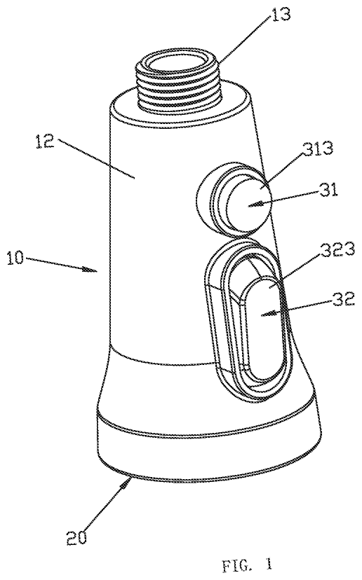

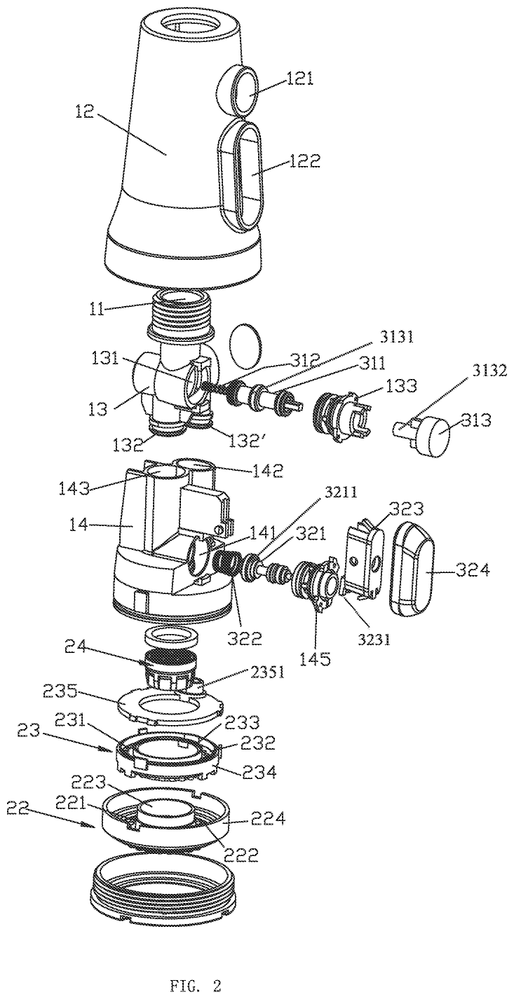

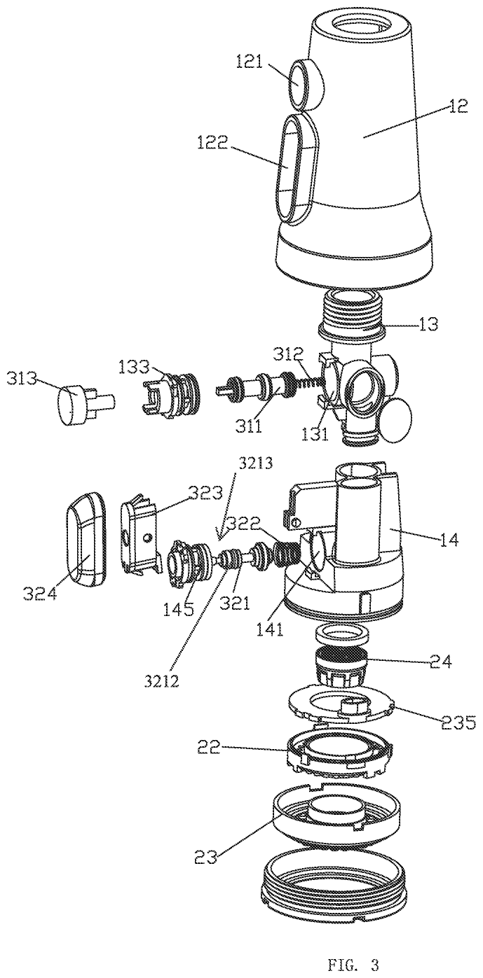

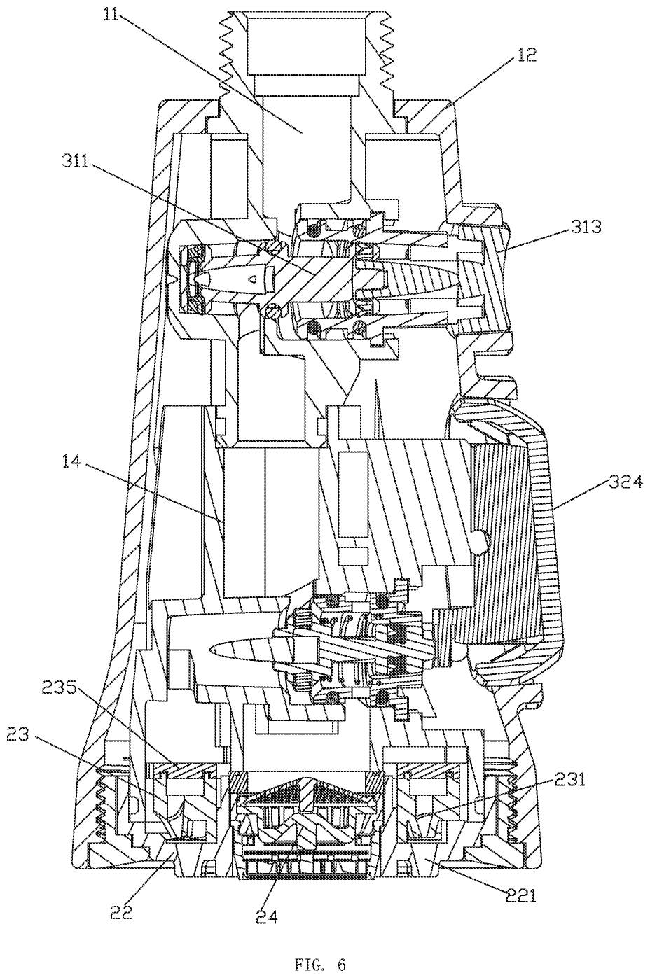

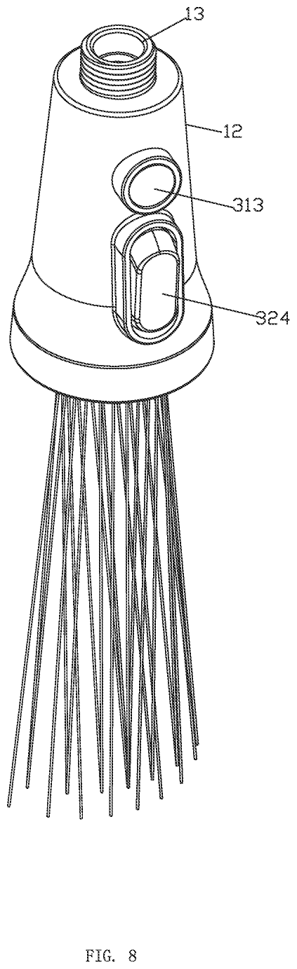

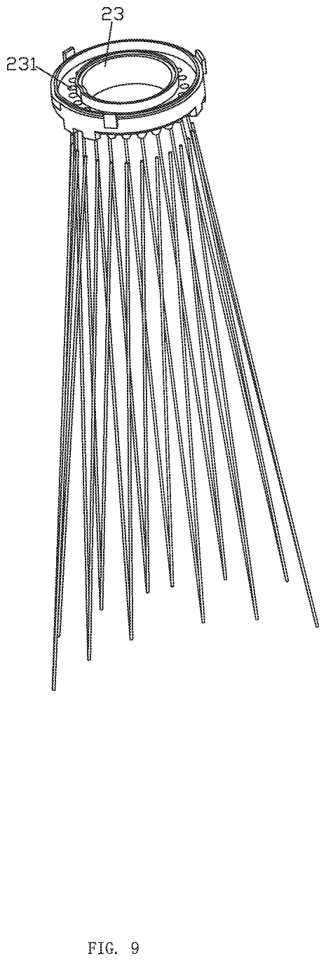

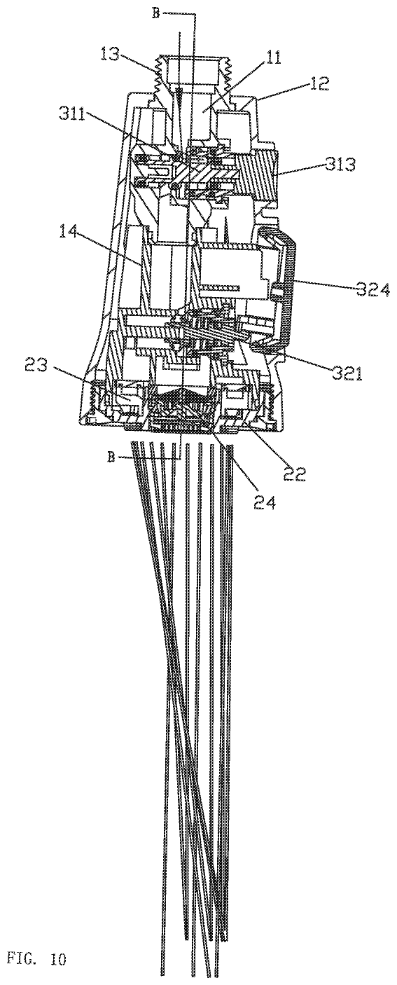

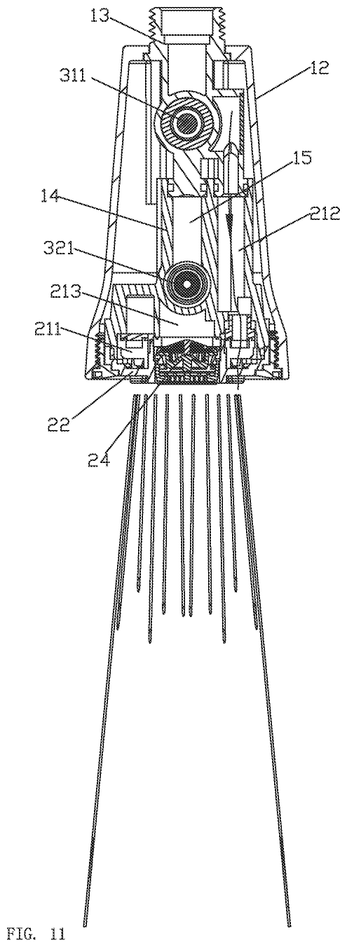

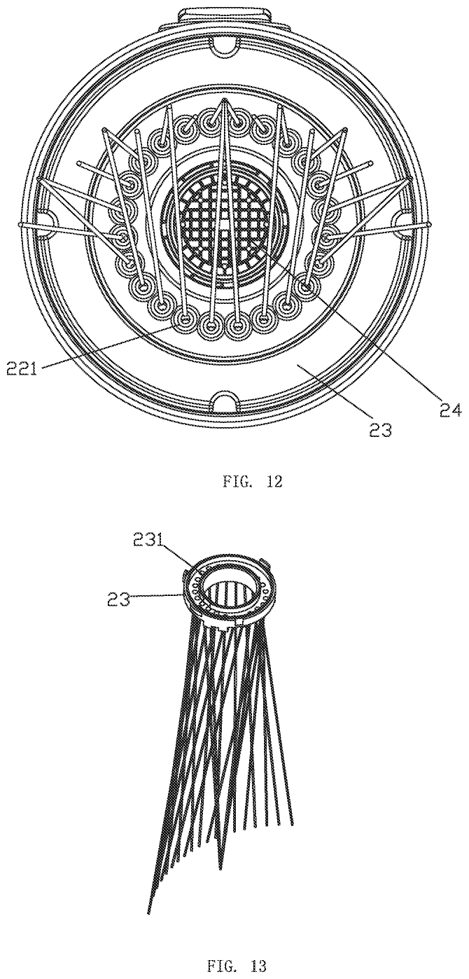

Referring to FIGS. 1-12, a kitchen faucet comprises a body portion 10, a waterway control device, and a water outlet device 20. The body portion 10 comprises a water inlet passage 11. The water outlet device 20 comprises three water outlet passages 211, 212, and 213, a first water outlet portion 22 comprising one or more first water outlet nozzles 221, one or more second water outlet portions 23 comprising one or more second water outlet nozzles 231, and a third water outlet portion 24. The waterway control device is connected to the water inlet passage 11 and the three water outlet passages 211, 212, and 213 to switch the three water outlet passages 211, 212, and 213 to be alternatively connected to the water inlet passage 11.

The body portion 10 comprises a body 12, a first water dividing body 13, and a second water dividing body 14. The body 12 has a housing structure. The first water dividing body 13 and the second water dividing body 14 are secured in the body 12, and the water outlet device 20 is secured on the body 12 and cooperates with the second water dividing body 14. The waterway control device comprises a first switching mechanism 31 and a second switching mechanism 32. The body portion 10 further comprises a water dividing passage 15. The three water outlet passages 211, 212, and 213 are a first water outlet passage 211, a second water outlet passage 212, and a third water outlet passage 213. The first switching mechanism 31 is disposed on the first water dividing body 13 and is connected to the second water outlet passage 212, the water dividing passage 15, and the water inlet passage 11 to switch the second water outlet passage 212 and the water dividing passage 15 to be alternatively connected to the water inlet passage 11. The second switching mechanism 32 is connected to the water dividing passage 15, the first water outlet passage 211, and the third water outlet passage 213 to switch the first water outlet passage 211 and the third water outlet passage 213 to be alternatively connected to the water dividing passage 15. In this embodiment, the waterway control device comprises two switching mechanisms. In other embodiments, one switching mechanism can be used to switch the three water outlet passages 211, 212, and 213 to be alternatively connected to the water inlet passage 11.

In some embodiments: the first water dividing body 13 is recessed to define a first water dividing cavity 131, a first pipeline penetrating from the first water dividing cavity 131 to an upper port of the first water dividing body 13, and two second pipelines in communication with the first water dividing cavity 131. The water inlet passage 11 comprises the first pipeline, the water dividing passage 15 comprises a first second pipeline 132 of the two second pipelines, and the second water outlet passage 212 comprises a second second pipeline 132′ of the two second pipelines. A concave opening of the first water dividing cavity 131 is secured with a basis body 133. The first switching mechanism 31 is disposed in the first water dividing cavity 131 to achieve waterway switching, and the first switching mechanism 31 comprises a sliding shaft 311 slidably connected to the basis body 133, a first spring 312, and a button 313. The sliding shaft 311 is secured with a seal ring 3131. The first spring 312 abuts and is disposed between a bottom of the first water dividing cavity 131 and the sliding shaft 311, and the button 313 is slidably disposed in a sliding hole 121 penetrating an inner side and an outer side of the body 12. An inner end of the button 313 is secured with an abutting rod 3132, and the abutting rod 3132 abuts an outer end of the sliding shaft 311. Therefore, the sliding shaft 311 is disposed on an outer side (i.e., a position adjacent to an outer side of the basis body 133) and the seal ring 3131 is hermetically sealed to the second second pipeline 132′ (when in an initial state) due to an elastic force of the first spring 312, and the first second pipeline 132 is open. The button 313 is pressed, the button drives the sliding shaft 311 to slide inward, so that the seal ring 3131 is hermetically sealed to the first second pipeline 132 and the second second pipeline 132′ is open. When the button 313 is long pressed (i.e., pressed and held for at least a couple seconds), water flows out of the second water outlet portion 23, and when the button 313 is released, water flows out of the third water outlet portion 24 (in this state, if the water is stopped, the sliding shaft 311 will be reset to the initial state).

The second water dividing body 14 is concave to define a second water dividing cavity 141, a fourth pipeline 143 penetrating from the second water dividing cavity 141 to an upper port of the second water dividing body 14, and two fifth pipelines in communication with the second water dividing cavity 141. The second water dividing body 14 further comprises a third pipeline 142 penetrating an upper end and a lower end of the second water dividing body 14. The third pipeline 142 and the fourth pipeline 143 of the second water dividing body 14 respectively encompass and are connected to the two second pipelines 132 and 132′ of the first water dividing body 13. The second water outlet passage 212 comprises the third pipeline 142, and the second second pipeline 132′ is in communication the third pipeline 142. The water dividing passage 15 comprises the fourth pipeline 143, and the first second pipeline 132 is in communication with the fourth pipeline 143. The first water outlet passage 211 comprises a first fifth pipeline 144′ of the two fifth pipelines, and the third water outlet passage 213 comprises the second fifth pipelines 144 of the two fifth pipelines. A valve body 145 is secured on the second water dividing cavity 141. The second switching mechanism 32 is disposed on the second water dividing body 14. The second switching mechanism 32 comprises a valve core 321 slidably connected to the valve body 145, a second spring 322, and a boat-shaped switch 323. The valve core 321 is secured with a seal ring 3211, and the second spring 322 abuts and is disposed between the valve core 321 and the valve body 145. The boat-shaped switch 323 is swingably connected to the second water dividing body 14 and extends out of a give-way hole 122 penetrating the inner side and the outer side of the body 12. An inner side of the boat-shaped switch 323 is disposed with a dial fork 3231, and the valve core 321 comprises a protruding end 3213 extending out of the valve body 145. The protruding end 3213 is annularly recessed to define an annular groove 3212. The dial fork 3231 is disposed in the annular groove 3212. Therefore, the valve core 321 is disposed on an inner side (i.e., a position adjacent to an inner side of the valve body 145) and the seal ring 3211 is hermetically sealed to the first fifth pipeline 144′ (when in an initial state) due to an elastic force of the second spring 322, and the second fifth pipeline 144 is open. When the boat-shaped switch 323 is pressed, the boat-shaped switch 323 drives the valve core 321 to slide outward, so that the seal ring 3211 is hermetically sealed to the second fifth pipeline 144, and the first fifth pipeline 144′ is open. Further, the second switching mechanism 32 is maintained in this state due to water pressure (in this state, if the water is stopped, the valve core 321 will be reset to the initial state).

Each of the first water outlet portion 22 and the second water outlet portion 23 has a circular annular structure, and the second water outlet portion 23 is separated from the first water outlet portion 22 in an upper and lower direction (i.e., in a vertical direction). The third water outlet portion 24 is disposed in annular structures of the first water outlet portion 22 and the second water outlet portion 23. The three water outlet passages 211, 212, and 213 are respectively in communication with the one or more first water outlet nozzles 221, the one or more second water outlet nozzles 231, and the third water outlet portion 24. The one or more first water outlet nozzles 221 comprise a plurality of first water outlet nozzles 221, and the one or more second water outlet nozzles 231 comprise a plurality of second water outlet nozzles 231. The plurality of first water outlet nozzles 221 of the first water outlet portion 22 are annularly arrayed relative to an axis of the circular annular structures (i.e., evenly and circumferentially disposed at intervals), and the plurality of second water outlet nozzles 231 of the second water outlet portion 23 are annularly arrayed relative to the axis of the circular annular structures (i.e., evenly and circumferentially disposed at intervals). Further, the plurality of first water outlet nozzles 221 are aligned with the plurality of second water outlet nozzles 231 in the upper and lower direction, and the plurality of second water outlet nozzles 231 correspond to the plurality of first water outlet nozzles 221 to enable fluid ejected from the plurality of second water outlet nozzles 231 to pass through the plurality of first water outlet nozzles 221. In some embodiments, in a projection along an ejecting direction of the plurality of second water outlet nozzles 231, inner walls of the plurality of first water outlet nozzles 221 encompass water outlet ports of the plurality of second water outlet nozzles 231 and are respectively separated from water outlet ports of the plurality of second water outlet nozzles 231 by gaps, so that the fluid ejected from the plurality of second water outlet nozzles 231 is configured to pass through the plurality of first water outlet nozzles 221.

In this embodiment, the first water outlet portion 22 comprises a first water outlet cover 222 defining an annular structure. An inner periphery and an outer periphery of the first water outlet cover 222 respectively extend upward to define a first inner peripheral wall 223 and a first outer peripheral wall 224, and the first water outlet cover 222 comprises the plurality of first water outlet nozzles 221. The second water outlet portion 23 comprises a second water outlet cover 232 defining an annular structure. An inner periphery and an outer periphery of the second water outlet cover 232 respectively extend upward to define a second inner peripheral wall 233 and a second outer peripheral wall 234, and the second water outlet cover 232 comprises the plurality of second water outlet nozzles 231. The second water outlet portion 23 is disposed between the first inner peripheral wall 223 and the first outer peripheral wall 224, and the second water outlet cover 232 is separated from the first water outlet cover 222 in the upper and lower direction. Further, ends of the plurality of second water outlet nozzles 231 are separated from the first water outlet cover 222 in the upper and lower direction by a gap, so that the ends of the plurality of second water outlet nozzle 231 are separated from an inner end surface defined by inner ports of the plurality of first water outlet nozzle 221 in the upper and lower direction by a gap to prevent water discharge of the plurality of first water outlet nozzles 221 from being interfered with by the plurality of second water outlet nozzles 231. In some embodiments, the first outer peripheral wall 224 is secured in a lower port of the body 12. An annular plate 235 is secured between the second inner peripheral wall 233 and the second outer peripheral wall 234 of the second water outlet portion 23, and a second water outlet cavity B is defined between the second water outlet portion 23 and the annular plate 235. The annular plate 235 is disposed with a joint 2351 in communication with the second water outlet cavity B. A first water outlet cavity A is defined between the first water outlet portion 22 and the second water outlet cover 232. The first water outlet passage 211 comprises the first water outlet cavity A, and the first fifth pipeline 144′ is in communication with the first water outlet cavity A. The second water outlet passage 212 comprises the second water outlet cavity B, and the third pipeline 142 is in communication with the joint 2351 and is in communication with the second water outlet cavity B. The annular structure can define a circular annular shape, an elliptical annular shape, a rectangular annular shape, etc.

At least some second water outlet nozzles 231 of the plurality of second water outlet nozzles 231 are divided into two second water outlet nozzle groups. The fluid ejected from the two second water outlet nozzle groups intersects in different planes or collides. For example, in a situation where the fluid intersects in the different planes, an intersecting area in the different planes defines a focus area. For example, in a situation where the fluid collides, a collision area defines the focus area. In this embodiment, at least some second water outlet nozzles 231 of the plurality of second water outlet nozzles 231 are divided into two second water outlet nozzle groups. The fluid ejected from the two second water outlet nozzle groups intersects in different planes, and an intersecting position of the different planes defines the focus area. Fluid ejected from the remaining second water outlet nozzles 231 of the plurality of second water outlet nozzles 231 collides between the water outlet device 20 and the focus area. Further, a cross section of the fluid ejected from the two second water outlet nozzle groups defines an arc-shaped lattice structure at the focus area, and collision points of the remaining second water outlet nozzles 231 also define an arc-shaped lattice structure. In some embodiments, directions of the ejected fluid are controlled due to designing tangent lines of outer ports of the plurality of second water outlet nozzles 231. The collision or the intersection in different planes is controlled, and directions of the ejected fluid are controlled to define arc shapes or other structures.

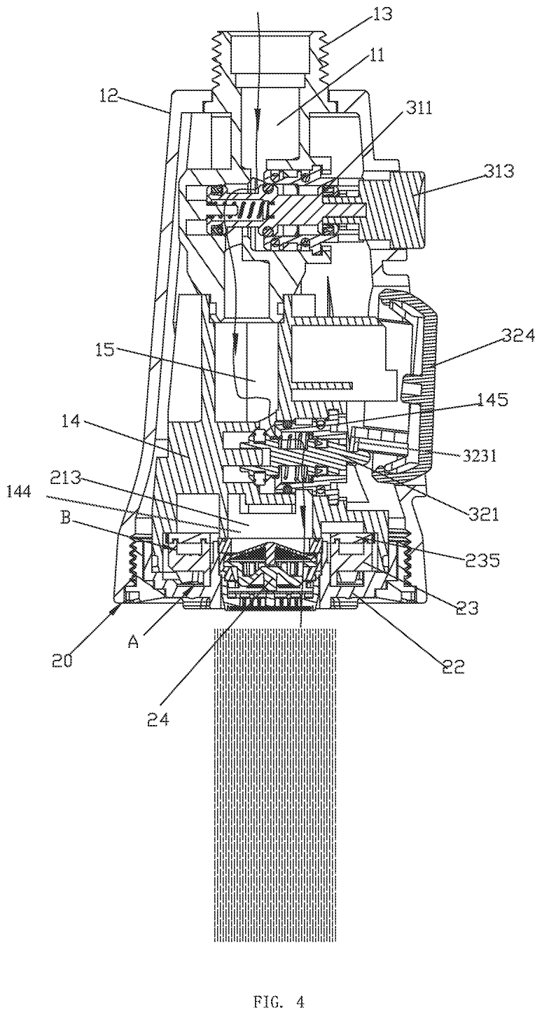

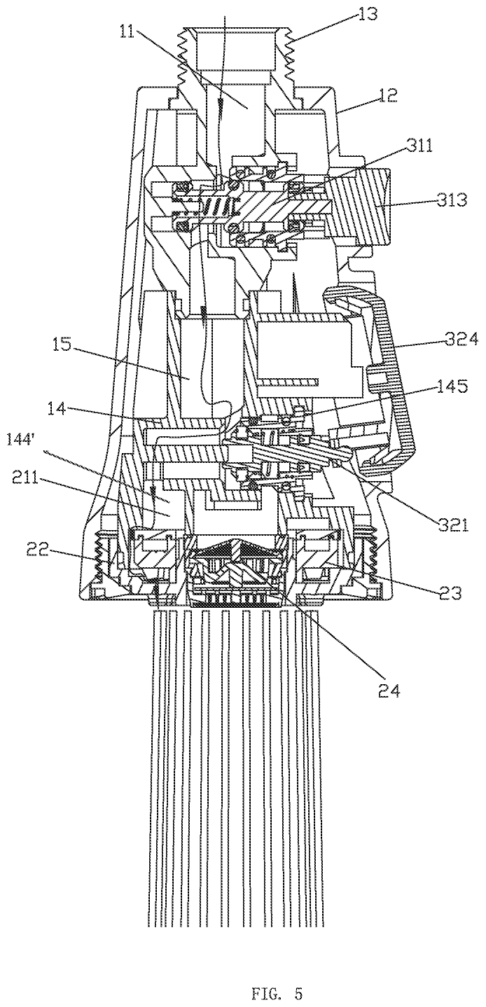

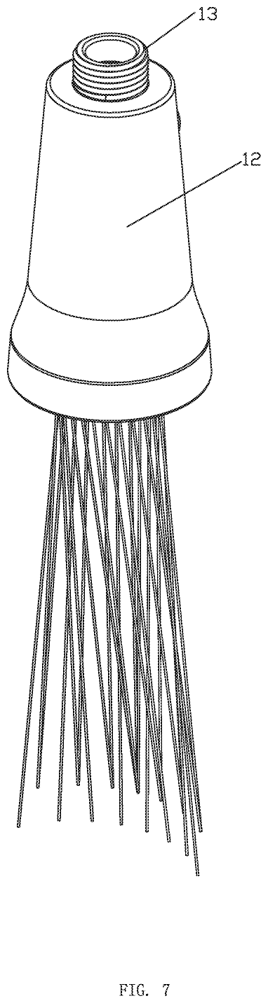

Referring to FIG. 4, in the initial state, under actions of the first spring 312 and the second spring 322, the third water outlet passage 213 is in communication with the third water outlet portion 24. The third water outlet portion 24 is, for example, an aerator. Referring to FIG. 5, the boat-shaped switch 324 is pressed to overcome the elastic force of the second spring 322 to drive the seal ring 3211 to move to achieve switching, and water flows out of the first water outlet passage 211. The first water outlet portion 22 is, for example, a shower. The seal ring 3211 is maintained in this position by the water pressure due to an area difference, and the water outlet device 20 is maintained in a shower water state. Referring to FIGS. 7-12, the button 313 is pressed to overcome the elastic force of the first spring 312 to drive the seal ring 3131 to move to achieve switching, water flows out of the second water outlet passage 212, and the second water outlet portion 23 is, for example, an arc-shaped sheet shower. The seal ring 3131 is maintained in this position by water pressure due to the area difference, and the water outlet device 20 is maintained in an arc-shaped sheet shower water state. The shower water with different water discharging angles also defines different water sprays. For example, the shower water and the arc-shaped sheet shower water are different water sprays.

The kitchen faucet in this embodiment can achieve three different types of water sprays, an appearance is simple, functions are various, and the kitchen faucet can concurrently achieve the requirements that aerated water is configured to be added without splashing, conventional shower water is configured to wash vegetables, and arc-shaped sheet shower water has strong strength and large coverage area and is easy to accumulate leftovers when washing. At the same time, some water sprays of the arc-shaped sheet water with greater impact collide in front of the focus area to define a granular water curtain to prevent water from splashing after collusion to plates occurs.

### Embodiment 2

Referring to FIG. 13, this embodiment differs from Embodiment 1 in that the a cross section of the fluid ejected from the two second water outlet nozzle groups defines an arc-shaped lattice structure at the focus area, and the arc-shaped lattice structure encompasses the collision point. In some embodiments, only two second water outlet nozzles 231 of the plurality of second water outlet nozzles 231 collide to define one collision point, or some of the plurality of second water outlet nozzles 231 collide to define one collision point.

### Embodiment 3

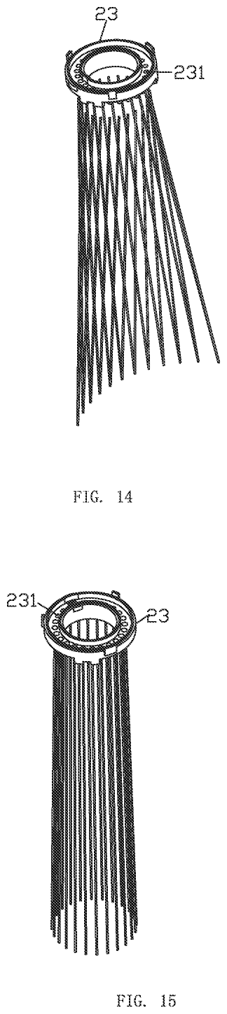

Referring to FIG. 14, this embodiment differs from Embodiment 1 in that the plurality of second water outlet nozzles 231 are all divided into two second water outlet nozzle groups, and the fluid ejected from the two second water outlet nozzle groups collide in the focus area. The cross section of the fluid ejected from the two second water outlet nozzle groups defines an arc-shaped lattice structure at the focus area.

### Embodiment 4

Referring to FIG. 15, this embodiment differs from Embodiment 1 in that the plurality of second water outlet nozzles 231 is obliquely and outwardly disposed, so that the exiting water has a tapered shape. Since the plurality of second water outlet nozzles 231 are configured to pass through the plurality of first water outlet nozzles 221, apertures of the plurality of second water outlet nozzles 231 are smaller than apertures of the plurality of first water outlet nozzles 221, and water discharging force is stronger.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A water outlet device, comprising:
three water outlet passages,
a first water outlet portion comprising one or more first water outlet nozzles,
a second water outlet portion comprising one or more second water outlet nozzles, and
a third water outlet portion, wherein:
each of the first water outlet portion and the second water outlet portion respectively has an annular structure,
the second water outlet portion is separated from the first water outlet portion in an upper and lower direction,
the one or more second water outlet nozzles correspond to the one or more first water outlet nozzles to enable fluid ejected from the one or more second water outlet nozzles to pass through the one or more first water outlet nozzles,
the third water outlet portion is disposed in the annular structures of the first water outlet portion and the second water outlet portion, and
the three water outlet passages are respectively in communication with the one or more first water outlet nozzles, the one or more second water outlet nozzles, and the third water outlet portion.

2. The water outlet device according to claim 1, wherein ends of the one or more second water outlet nozzles are separated from an inner end surface defined by inner ports of the one or more first water outlet nozzles in the upper and lower direction by a gap.

3. The water outlet device according to claim 1, wherein:
the second water outlet portion is separated from the first water outlet portion in the upper and lower direction to define an area, and
the area defines a portion of a first water outlet passage of the three water outlet passages in communication with the one or more first water outlet nozzles.

4. The water outlet device according to claim 1, wherein:
the one or more first water outlet nozzles comprises a plurality of first water outlet nozzles,
the plurality of first water outlet nozzles are evenly and circumferentially disposed at intervals,
the one or more second water outlet nozzles comprises a plurality of second water outlet nozzles, and
the plurality of second water outlet nozzles are evenly and circumferentially disposed at intervals.

5. The water outlet device according to claim 4, wherein:
the annular structures of the first water outlet portion and the second water outlet portion are circular annular structures,
the plurality of first water outlet nozzles and the plurality of second water outlet nozzles are both annularly arrayed relative to axis of the circular annular structures, and
the plurality of second water outlet nozzles are aligned with the plurality of first water outlet nozzles in the upper and lower direction.

6. The water outlet device according to claim 1, wherein:
the first water outlet portion comprises a first water outlet cover defining a first annular structure,
an inner periphery and an outer periphery of the first water outlet cover respectively extend upward to define a first inner peripheral wall and a first outer peripheral wall,
the first water outlet cover comprises the one or more first water outlet nozzles,
the second water outlet portion comprises a second water outlet cover defining a second annular structure,
an inner periphery and an outer periphery of the second water outlet cover respectively extend upward to define a second inner peripheral wall and a second outer peripheral wall,
the second water outlet cover comprises the one or more second water outlet nozzles,
the second water outlet portion is disposed between the first inner peripheral wall and the first outer peripheral wall, and
the second water outlet cover is separated from the first water outlet cover in the upper and lower direction.

7. The water outlet device according to claim 1, wherein in a projection along an ejecting direction of the one or more second water outlet nozzles, inner walls of the one or more first water outlet nozzles encompass water outlet ports of the one or more second water outlet nozzles.

8. The water outlet device of claim 1, wherein:
the one or more first water outlet nozzles comprise a plurality of first water outlet nozzles,
the one or more second water outlet nozzles comprise a plurality of second water outlet nozzles, and
fluid ejected from at least two second water outlet nozzles of the plurality of second water outlet nozzles collides in a focus area or collides between the water outlet device and the focus area.

9. The water outlet device of claim 8, wherein:
at least some second water outlet nozzles of the plurality of second water outlet nozzles are divided into two second water outlet nozzle groups,
fluid ejected from the two second water outlet nozzle groups collides in the focus area or collides between the water outlet device and the focus area, and
collision points of the two second water outlet nozzle groups define an arc-shaped lattice structure.

10. The water outlet device according to claim 8, wherein:
the plurality of second water outlet nozzles are all divided into two second water outlet nozzle groups, and
fluid ejected from the two second water outlet nozzle groups collides in the focus area.

11. The water outlet device according to claim 8, wherein:
at least some second water outlet nozzles of the plurality of second water outlet nozzles are divided into two second water outlet nozzle groups,
fluid ejected from the two second water outlet nozzle groups intersects in different planes,
an intersecting position of the different planes defines the focus area, and
fluid ejected from remaining second water outlet nozzles of the plurality of second water outlet nozzles not divided into the two second water outlet nozzle groups collides between the water outlet device and the focus area.

12. The water outlet device of claim 11, wherein a cross section of the fluid ejected from the two second water outlet nozzle groups defines an arc-shaped lattice structure at the focus area.

13. The water outlet device according to claim 11, wherein:
a cross section of the fluid ejected from the two second water outlet nozzle groups defines a first arc-shaped lattice structure at the focus area, and
collision points of the remaining second water outlet nozzles define a second arc-shaped lattice structure.

14. The water outlet device according to claim 11, wherein:
a cross section of the fluid ejected from the two second water outlet nozzle groups defines in an arc-shaped lattice structure at the focus area, and
the arc-shaped lattice structure surrounds collision points of the remaining second water outlet nozzles.

15. The water outlet device of claim 1, wherein:
the one or more first water outlet nozzles comprise a plurality of first water outlet nozzles,
the one or more second water outlet nozzles comprise a plurality of second water outlet nozzles,
at least some second water outlet nozzles of the plurality of second water outlet nozzles are divided into two second water outlet nozzle groups,
fluid ejected from the two second water outlet nozzle groups intersect in different planes,
an intersecting position of the different planes defines a focus area, and
a cross section of the fluid ejected from the two second water outlet nozzle groups defines an arc-shaped lattice structure in the focus area.

16. A water outlet device, comprising:
a first water outlet passage,
a first water outlet portion comprising one or more first water outlet nozzles,
a second water outlet passage, and
a second water outlet portion comprising one or more second water outlet nozzles, wherein:
the one or more first water outlet nozzles are in communication with the first water outlet passage,
the one or more second water outlet nozzles are in communication with the second water outlet passage,
the second water outlet portion is separated from the first water outlet portion in an upper and lower direction,
ends of the one or more second water outlet nozzles are separated from an end surface defined by inner ports of the one or more first water outlet nozzles in the upper and lower direction by a gap, and
the one or more second water outlet nozzles correspond to the one or more first water outlet nozzles to enable fluid ejected from the one or more second water outlet nozzles to pass through the one or more first water outlet nozzles.

17. A water outlet device, comprising:
a water outlet passage, and
a water outlet portion comprising a plurality of water outlet nozzles, wherein:
the plurality of water outlet nozzles are in communication with the water outlet passage, and
fluid ejected from at least two water outlet nozzles of the plurality of water outlet nozzles collides in a focus area or collides between the water outlet device and the focus area.

18. A kitchen faucet, comprising:
a body portion,
a waterway control device, and
the water outlet device according to claim 1, wherein:
the body portion comprises a water inlet passage, and
the waterway control device is connected to the water inlet passage and the three water outlet passages so as to alternatively switch the three water outlet passages to be in communication with the water inlet passage.

19. The kitchen faucet according to claim 18, wherein:
the waterway control device comprises a first switching mechanism and a second switching mechanism,
the body portion comprises a water dividing passage,
the three water outlet passages are respectively a first water outlet passage, a second water outlet passage, and a third water outlet passage,
the first switching mechanism is connected to the second water outlet passage, the water dividing passage, and the water inlet passage to alternatively switch the second water outlet passage and the water dividing passage to be in communication with the water inlet passage, and
the second switching mechanism is connected to the water dividing passage, the first water outlet passage, and the third water outlet passage to alternatively switch the first water outlet passage and the third water outlet passage to be in communication with the water dividing passage.

20. The kitchen faucet according to claim 19, wherein:
the body portion comprises a body, a first water dividing body, and a second water dividing body,
the first water dividing body and the second water dividing body are disposed in the body,
the water outlet device is secured to the body and cooperates with the second water dividing body,
the first switching mechanism is disposed on the first water dividing body, and
the second switching mechanism is disposed on the second water dividing body.
